(19) United States
(12) Patent Application Publication
(10) Pub. No.: US 2010/0107165 A1
(43) Pub. Date: Apr. 29, 2010

(54) METHOD, SYSTEM, AND APPARATUS FOR PROCESS MANAGEMENT

(76) Inventors: OSKARI KOSKIMIES, HELSINKI (FI); ANSSI KARHINEN, VANTAA (FI); HARRI VEIKKO HEIKKILA, VANTAA (FI)

Correspondence Address: DITTHAVONG MORI & STEINER, P.C., 918 Prince Street, Alexandria, VA, 22314, US

(21) Appl. No.: 12/257,686

(22) Filed: Oct. 24, 2008

(51) Int. Cl. G06F 9/46

(52) U.S. Cl. 718/100

(57) ABSTRACT

Process management involves determining a thread from metadata embedded in an electronic document that used in the performance of a process via an electronic messaging operation. The thread includes data that collectively describes states and relationships of interrelated tasks of the process. User role data is determined from the thread, and processing the electronic document by a participant of the process is facilitated. Processing of the electronic document is governed by the user role data relative to a user role of the participant in the process.

### TECHNICAL FIELD

This specification relates in general to computer applications, and more particularly to systems, apparatuses, computer programs, and methods for process management.

### BACKGROUND

This disclosure relates to enhancing productivity using information technology (IT). For some time, commercial enterprises have used computer systems to automate and enhance their daily business processes. Among the first applications of computers were the basic processes found in most every enterprise: accounting, order management and customer registries.

The earliest computerized solutions sought to support the generic functions of a business process such as creating, storing, and sending documents, and managing one's contact networks. As these systems developed, features were added to automate complete enterprise-wide processes in such a way that the processes can be monitored and managed in a centralized fashion. This involved defining steps and information needed from each participant of the process in unambiguous terms.

These goals eventually led to the development of Business Process Modeling (BPM) methods such as the Zachman framework from 1980. These methods try to capture all aspects that are relevant to a particular business process. Another, technical development track produced Business Process Management Systems (BPMS) that had a goal of enabling an efficient way of creating specialized automated process implementations for any purpose by different enterprises. The first wave of commercial systems used automated generic processes that were similar among many enterprises, or were custom build from ground up to the requirements of a specific business process in an enterprise. New BPMS implementations claimed that they could automate any process in the enterprise involving both human participants and other computer applications.

Business Process Management systems are often model driven, e.g., they execute a formal model that defines the workflow of the automated process. A common technology to implement the model is the Business Process Execution Language (BPEL), but numerous other modeling languages have also been developed. In a some cases the model describes the structure of the state data of the process, and a sequence of interaction steps by external participants to modify the state. The model can also describe other resources, such as databases, needed by the process.

### SUMMARY

The present specification discloses systems, apparatuses, computer programs, data structures, and methods for process management. In one aspect, apparatuses, computer readable medium, and methods for process management determine a thread from metadata embedded in an electronic document that used in the performance of a process via an electronic messaging operation. The thread includes data that collectively describes states and relationships of interrelated tasks of the process. User role data is determined from the thread, and processing the electronic document by a participant of the process is facilitated. Processing of the electronic document is governed by the user role data relative to a user role of the participant in the process.

In one variation, a state of the thread is updated based on processing the electronic document and updating the metadata in response thereto. In such a case, the updated metadata can be communicated via the electronic messaging operation of the process to communicate the updated state of the thread and/or communicating the updated metadata my involve communicating the metadata embedded in a transferred electronic document that is sent via the electronic messaging operation.

In another variation, document type data of the electronic document is determined from the metadata. In such a case, processing of the electronic document is further governed by the document type data relative to a document type of the electronic document. In another particular aspect facilitating processing the electronic document by the participant of the process involves facilitating of the creation of the electronic document by the participant of the process and embedding the metadata into the electronic document. In such a case, facilitating creation of the electronic document may involve creating the document and the metadata based on a workflow template that models the tasks of the process. In any of the above aspects, the metadata may include a state table that maps the states of the tasks to possible states of the thread.

In another aspect, computer-readable storage medium stores a data structure that includes business data used in furthering completion of one or more tasks of interrelated tasks of a process via an electronic messaging operation. The data instructions further include metadata having thread data that collectively describes states and relationships of the interrelated tasks. The thread data further includes user role data that governs processing of the data structure by a participant of the process in accordance with a user role of the participant. The thread data further includes document type data that describes a type of at least the business data. The processing of the data structure is further governed by the document type data relative to the type of at least the business data. The metadata is configured to be transferred to other participants of the process via the electronic messaging operation to track state of a thread described by the thread data.

In one variation, the metadata further includes a state table that maps the states of the tasks to possible states of the thread. In another variation, the metadata includes a thread descriptor that indicates an identity of the thread, and the thread descriptor may include at least one of a subject of the thread, identities of participants in the process, and role information of the participants in the process

These and various other advantages and features of novelty are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments of the invention.

### BRIEF DESCRIPTION OF THE DRAWINGS

The invention is described in connection with example embodiments illustrated in the following diagrams.

FIGS. 1A-B is a block diagram illustrating interactions between roles and networks channels in a task management system according to an example embodiment of the invention;

FIG. 2 a block diagrams illustrating document flows in a task management system according to an example embodiment of the invention;

FIG. 3 is a block diagram illustrating process flow networks according to an example embodiment of the invention;

FIG. 4 is a block diagram illustrating distributing resources among process networks according to an example embodiment of the invention;

FIG. 5 is a block diagram illustrating a data structures of a document according to an example embodiment of the invention;

FIG. 6 is a block diagram illustrating a scenario utilizing thread state management according to an example embodiment of the invention;

FIG. 7 is a block diagram illustrating user interface views that reflect thread states of the scenario of FIG. 6 according to an example embodiment of the invention;

FIGS. 8-9 are block diagrams illustrating alternate user interface views thread states such as in the scenario of FIG. 6 according to an alternate example embodiment of the invention;

FIG. 10 is a block diagram of a user apparatus according to an example embodiment of the invention;

FIG. 11 is a block diagram of a service apparatus according to an example embodiment of the invention;

FIGS. 12A-B and 13A-B are flowcharts illustrating procedures according to example embodiments of the invention; and

FIG. 13 is a flowchart illustrating additional procedures according to an example embodiment of the invention

### DETAILED DESCRIPTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

Generally, the present disclosure is related to managing document flow in a task/process management system. Traditional BPMS provides the ability to track the status of individual process flows. For example one might observe when an order is submitted, who is handling it, when it has been confirmed and when it has been delivered. In a centralized system, task management process state can be tracked by a central server. Clients can update the state on the central server, and state changes can be quickly made visible to everyone who is online. In a distributed document flow system, a distributed solution that fits with the messaging-based communication paradigm is desirable. Such a distributed solution may also support offline use, e.g., targeted for mobile users with limited or intermittent network connectivity, or who may exchange data through direct/proximity data exchanges outside of a formal network.

In a centralized BPMS, participants may need to access a common, shared process instance. Attempts have been made to create distributed BPMS where each participant is either accessing a virtual copy of the shared process instance or only has its relevant part of the process description available locally. These systems, however, may lose some of the benefits that BPMS is supposed to deliver, such as immediate update of status to all interested parties.

The present disclosure relates to documents that are used to initiate, record, formalize, track, and/or notify parties about aspects of processes (e.g., business or workflow processes), including tasks, entities, individuals, tangible/intangible assets, projects, contracts, events, services, etc. In a document flow framework described herein, task management can be handled by organizing documents into “threads,” where each thread corresponds to a process. In the past, the concept of threads has been associated with email exchanges, online message boards, text message exchanges, Usenet groups, etc. In those types of communications, ongoing communications are grouped into threads according to a particular message or subject. The communications may be presented in some order (e.g., sorted by time created/received) and may be hierarchically arranged based on other factors (e.g., responses to a particular message may be grouped beneath the originally posted message).

As such term is used generally herein, threads are a data paradigm used to illustrate states and relationships of ongoing transactions. For example, the term “thread” may refer to data/executable objects that reside in user devices that reflect states of the underlying transactions. This thread object may also have a visual presentation component. The ongoing transactions represented by threads may include transfer of documents, tangible assets, written or verbal communications, etc. Further, the processes that are represented by threads need not be associated with for profit entities. Therefore, although example “business processes” may be described herein in terms of business organizations, those of skill in the art will appreciated that a “processes” or “business process” may include any form of tasks utilizing electronic message exchanges that collectively accomplish a defined goal in an orderly fashion. For example, common tasks performed by individuals, such as organizing a party, fundraising, community awareness, circulating petitions, etc., may involved exchanges that could be tracked via electronic messaging and represented as threads to participants.

In the present description, a document thread may have a state which describes the current overall state of the business process, e.g. “Order sent,” “Delivery received,” etc. Sub-processes can be represented as nested threads. A user interface that represents documents as threads may be sufficiently close to email to give users an intuitive understanding of how to use it. However, there such a system may exhibit differences from standard email. For example, standard email may not support nested threads, and threads may not exist as independent objects with their own attributes such as state.

In one example embodiment, each document carries one or more thread descriptors with it. These descriptors may reference any immediate parent threads (e.g., a thread the document directly belongs to), as well as any ancestor threads. Although in some implementations, a framework may limit a document to one parent thread (e.g., when hierarchy is represented as a tree graph), other implementations may allow multiple parent threads. When a document arrives, the client checks the descriptor of the immediate parent thread to determine if it already has a thread that matches the descriptor, and if it does, the document is attached to that thread. If the thread does not exist on the client, it is created and the document is attached to it. Some of the data needed to create a thread (e.g., subject, description, status, parent thread in case of nested threads) may come from the descriptor, and some may come from the document which caused the thread to be created. Finally, the other thread descriptors are checked and corresponding threads are created on the client if they do not exist already.

When a document is created based on another document (e.g. reply or forward), the thread descriptors in the original document can be copied to the new document. Sometimes a thread descriptor may be added (the new document begins a new thread) or one or more parent thread descriptors may be removed (the new document does not belong to those threads). The state of the thread may be updated by received documents which belong to the thread. Approaches for updating thread states are described below, a simple limited approach and a more flexible but possibly more complex approach. The simple approach may not fully handle nested threads, complex document flows, or thread completion status, but may be adequate for some problem domains.

For user interface (UI) purposes it may be desirable to know when a process has been completed, so that threads can be displayed differently (e.g. using a different icon) depending on whether the corresponding process has been completed or not. The way thread completion is determined and communicated may depend on the technical approach and the solution domain. Various example embodiments described further below exhibit some ways of showing thread completion.

Generally, the domain for the task management solutions described herein may include small and medium sized enterprises, individual professional users and consumers with the need for daily processes. Such solutions may be useful for individual users with no access to a fixed internet connection or a personal computer, e.g., those who may rely entirely on their mobile device instead. In some scenarios, it may not be possible or necessary to identify an owner for the process, and in some cases the participants can be peers to each other. In these instances, the users can form complex networks that they manage dynamically as their business contacts evolve. These networks may comprise the backbone for all communication within the daily processes of our users.

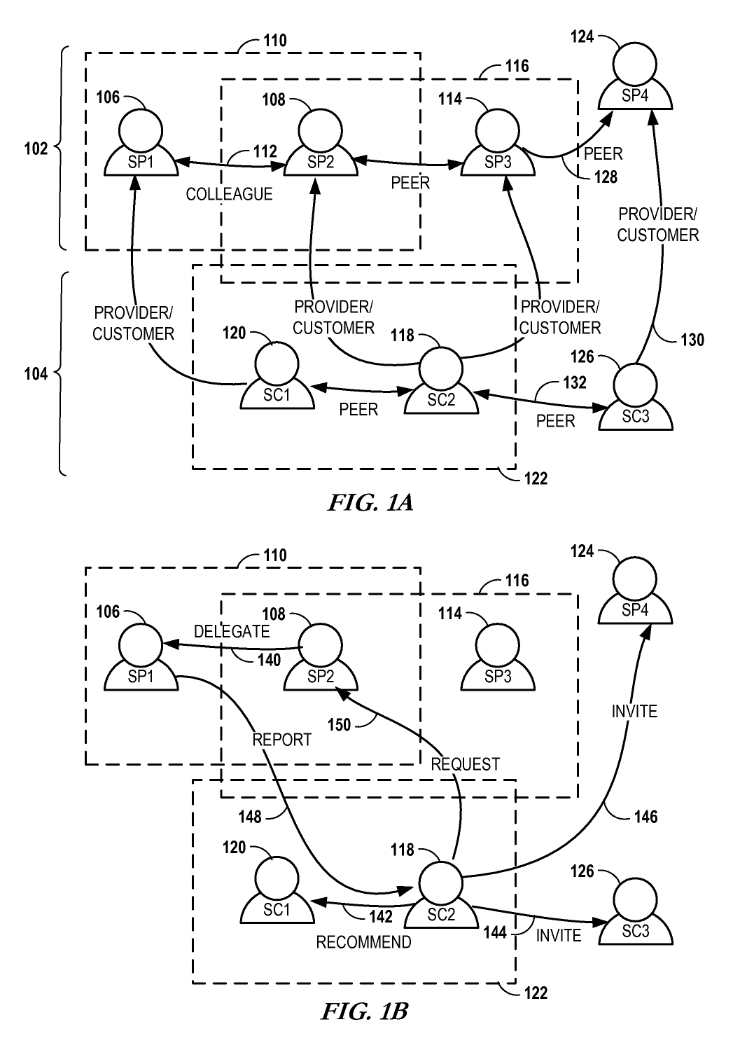

An example of entities that may utilize concepts of the invention is shown in the block diagram of FIGS. 1A-1B, wherein the same reference numbers are used to indicate similar components therebetween. The entities may be generally divided into service providers 102 and service consumers 104. The various service providers 102 and consumers 104 may be grouped into other categories. For example, service providers 106 and 108 may be grouped into a colleague network 110 of cooperating providers. This collegial relationship between service providers 106 and 108 is also indicated by path 112. Provider 108 is also related to service provider 114 as indicated by boundary 116. In this case, the relationship between service providers 108, 114 in this example is that these entities 108, 114 form a provider network 116 for service consumer 118. Further, service consumer 118 is part of a peer network 122 that includes service consumer 120. Finally service provider 124 and service consumer 126 may be independent of particular colleague/provider/peer networks 110, 116, 122, but may still have established relationships with other entities within those networks 110, 116, 122, as indicated by paths 128, 130, and 132.

The users form these (and other) networks 110, 116, 122 to dynamically manage transactions as their business contacts evolve. These networks 110, 116, 122 may include the backbone for some or all of the communication within the daily processes of our users. The networks 110, 116, 122 can be as simple or complex as the underlying interrelations for which the networks 110, 116, 122 are used. For example, the networks 110, 116, 122 can be somewhat informal in their nature, e.g., “myNeighbors”, or more businesslike and formal, e.g., “myCustomers”. Daily processes of the participants may be conducted among these networks 110, 116, 122.

In reference now FIG. 1B, a block diagram illustrates various document flows between entities shown in FIG. 1A. These flows include documents that define, initiate, support, record, and otherwise facilitate business processes such as inter-service delegation 140, inter-customer recommendations 142, inter-customer invitations 144, 146, customer-to-provider requests 150 and reports 148 in response to the requests 150. The documents related to these various flows 140, 142, 144, 146, 148, 150 may change over different times in the business process. For example, the request 150 may include documents with various blank/unknown values that will be filled in by one or more of the service providers 106, 108, before, during, and/or after delegation 140 and reporting 148. The framework described below includes features that enable tracking these changes in the processes based on status of the documents exchanged as part of tasks/events of the processes.

One aspect of a document management framework relates to how the users are able to understand and customize the solutions that are provided to them. Some users may be expected to craft their own services from the ground up with the tools provided. In other cases, easy to use templates may be provided that cover certain common or well-known tasks. Other technical features example embodiments described herein may include, but are not limited to: a) allowing participants to perform relevant (daily) activities without network access to a central service; b) mapping process concepts directly to existing physical document-based processes to facilitate the understanding of the concepts by the service participants without steep learning curve; c) facilitating maintenance of application specific networks for each participant; and d) support controlled sharing of data resources within the same communication architecture used for the flow implementation.

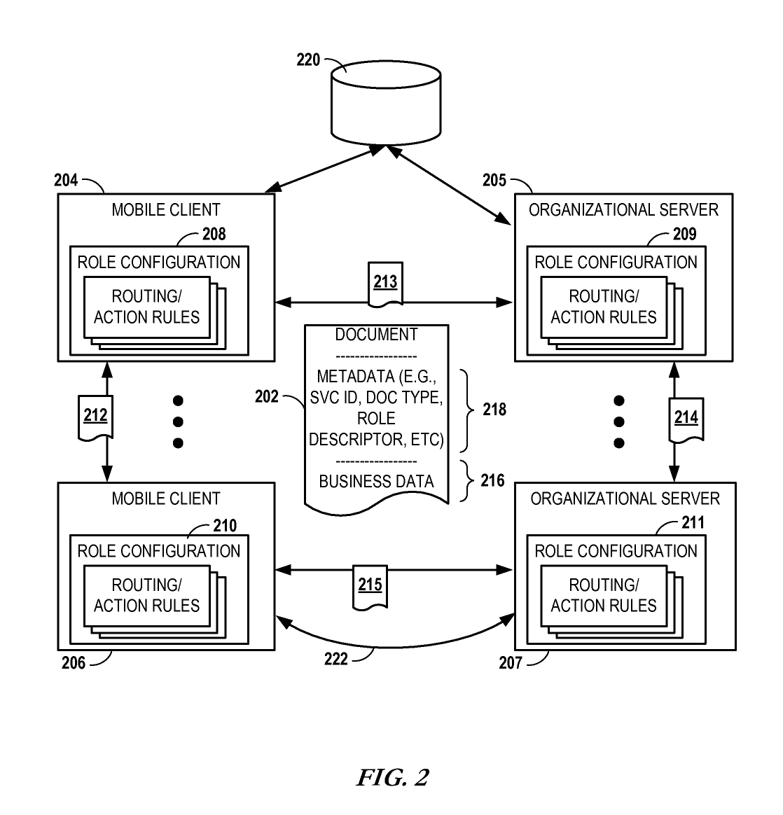

The example embodiments described below provide user customizable mobile processes in business domains. One approach is a document centric workflow model that is based on message passing paradigm. The model promotes participant autonomy and push type activity assignment. In FIG. 2, a block diagram illustrates communication flows in a distributed mobile document system according to an example embodiment of the invention. The participants of the flow communicate by sending documents (e.g., document 202) to each other. The communication nodes (e.g., mobile clients 204, 206 and servers 205, 207) may be “store-and-forward” type processing nodes that facilitate easy and intuitive operation in difficult connectivity conditions. The nodes 204-207 include respective role configuration modules 208-211 that each maintain and apply routing/action rules for processing and routing various documents 212-215 that circulate through the system.

As seen in the example embodiment of FIG. 2, there can be two types of participants in document flow. Phone users are represented by mobile clients 204, 206 and organizations that are represented by servers 205, 207, referred to herein as organizational servers. The servers 205, 207 may be connected to the fixed Internet, and may be peers in a document flow process. The mobile clients 204, 206 may also communicate between each other as peers, and with organizational servers 205, 207 as peers and/or as client-server.

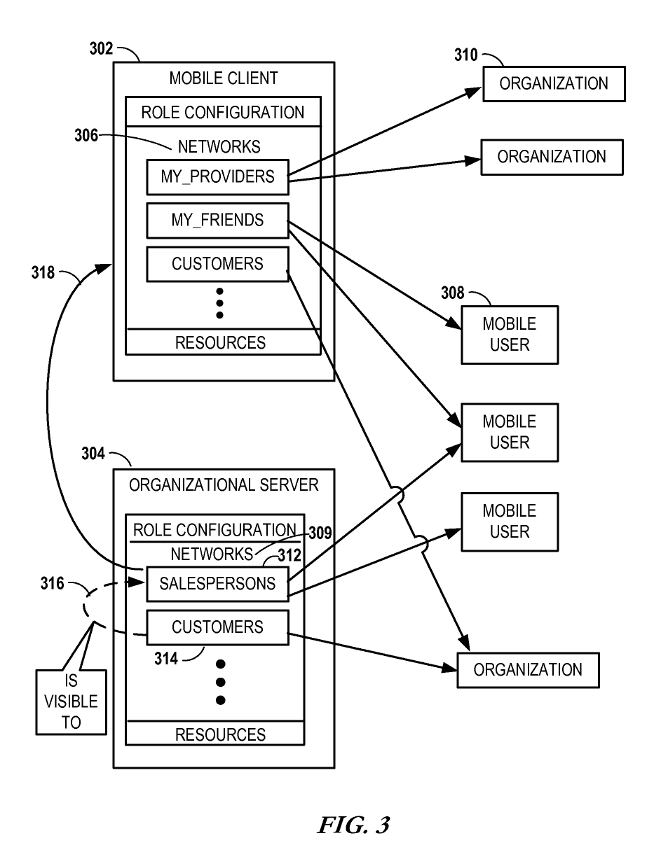

In an example of how an organizational server 207 may participate in document flows, consider the case where a customer with mobile client 206 sends an order document 215 to a service provider company. The company's organizational server 207 receives the document and reacts to it by finding a routing rule from its role configuration 211. Such rule may generally correspond to the “order” document type and the company's role in the role descriptor in the document 215. The role information in such a case could be “Service Provider=Company X.” The routing rule may say that the organizational server 207 should forward the order document 215 to one of the mobile users in the “salespersons” network in the organizational server instance of company X (see. e.g., FIG. 3).

In this example scenario, the organizational server 207 represents a communication end-point for a company, and in this capacity may act as an intermediary between the customers of the company and the workers of the company. It is possible that the organizational server creates new documents based on the documents it receives, in which case the meta information may be copied from the original document 215 to the created one.

As shown in document 202, each document in the system carries business data 216 that is relevant to the application of the flow, e.g., order rows. Each document of the system may also include structured metadata 218 that can be interpreted by all participants of the flow and used for various purposes. For instance, the forms used to handle a document are selected based on the user's role and document type. Therefore, the user's role may be defined for every document that is received. To ensure this, the receiving user's role may be required to be known and/or bound before a document can be sent.

Among the various uses of the metadata 218 is the reporting of state of a thread of a business process. The state of the thread may be collectively determined by the states of individual interrelated tasks that are implemented using the documents 212-215. As such, it is possible that no centralized entity is needed to track these process states, as the documents 212-215 themselves contain sufficient data for participating nodes to determine thread states of interest. For example, the nodes 205-207 may be able to determine thread state associated with all documents 212-215 that pass through the nodes 205-207. However, it may still be desirable to provide alternate means of communicating states of tasks, documents, and threads of the business process networks. For example, if document 212 was not directly communicated between clients 204 and 206, but passed through intermediaries, the clients 204, 206 may not have any way of determining state changes of the documents.

In some embodiments, state updates can be passed by sending documents which have no other purpose than passing the state update. For instance, when a customer makes an order to a supplier, the supplier sends back an order confirmation document which contains both a state update to “confirmed” and also some additional information like estimated delivery date. This kind of document would be visible in the user interface as a separate document which can be opened to view the additional information. However, another possibility would be that the order confirmation document only contains the state update to “confirmed”, and does not contain any additional information. In this case, the document might not even be visible in the user interface as a separate document, and the only visible result of receiving it is that the thread's state changes to “confirmed”. This kind of pure state update documents can be used to send targeted state updates using the normal document sending mechanisms.

Another way of detecting changes to process state is to ensure the documents 212-215 (or at least the metadata 218 of the documents 212-215) are stored in a central repository 220 by each entity that handles the documents 212-215 and/or effects changes to the metadata 218. The identity of the repository 220 may be embedded (e.g., as a URI) in the documents 212-215 themselves, or may be preconfigured by participating entities 204-207. This may be used to supplement the embedded metadata approach in some embodiments.

Another way that the workflow state data can be distributed is by embedding identifiers (e.g., URLs, user identities, messaging addresses) of participants in the workflow. These participant identifiers could be attached with portions of the metadata, such that only particular changes to document/task/thread state will be communicated based on, for example, the role of the participant in the business flow. This state data could be communicated using out of band mechanisms (e.g., mechanisms that are independent of those used to communicate documents 212-215), as indicated by alternate data path 222 between client 206 and server 207.

These out of band mechanisms 222 may be supplementary to the embedding of data in electronic documents. For example, in some scenarios a participant may be unwilling or unable to process an electronic document. In that case, the participant may receive a paper document with a bar code. The participant may be able to determine and/or affect metadata stored elsewhere (e.g., in repository 220) that is associated an electronic version of the paper document. By scanning the bar code (e.g., with a mobile device) and entering data in a user interface (e.g., one simplified for mobile devices) the participant can still process data in a similar manner as other participants who receive the metadata embedded in electronic documents. In such a case, other electronic documents in the process may include a reference to the repository 220 embedded in the metadata, so that interested parties can retrieve thread states related to that individual, if needed.

It will be appreciated that the illustration of passing documents 212-215 is merely exemplary, and the concepts described in FIG. 2 are applicable to any type of document creation/communication, updating of document/task/thread state, defining roles etc. Communicating state changes using documents themselves and/or peer-to-peer out-of-band mechanisms 222 may allow devices with limited connectivity and/or bandwidth (e.g., mobile devices) to determine or communicate state changes without resorting to polling of servers. A technical effect of this is that network bandwidth usage is reduced and system reliability is increased, as it removes a possible single point of failure.

In reference now to FIG. 3, a block diagram shows another view of a business process architecture according to an example embodiment of the invention. As previously described, the business process any include any organized tasks that can be furthered by the exchange of electronic documents between individuals. In additional to an organization server 304 such as described in relation to FIG. 2, the architecture includes a mobile client 302 used for direct user interaction with documents. The architecture of the distributed document flow system includes at least the participants to the communication flows. These participants may include mobile clients (e.g., client 302) that represent the individuals participating in a document flow out in the field. Some participants can be organizations that are assumed to be fixed (e.g., non-mobile) in nature. The organizations are represented by organization server systems (e.g., organization server 304 and servers 204-207 in FIG. 2). For example a mobile sales agent in the field can send “purchase order” documents to the server that represents his company. However, the flows don't necessarily require organizational participants; some may be ad-hoc transactions undertaken between peers.

Both the mobile users and organizations have a roles and networks defined in respect to the document flow. For example in a document flow that implements a mobile ordering process, roles may be established such as sales agent, customer, provider company and order handler. Roles of a mobile user may utilize display and action forms that control how the user sees the incoming documents. For example, an “order confirmation” document in the ordering flow might appear to have some extra data for the sales agent compared to the customer. In such a case, a document of the sales agent might have access to a “cancel order” function on the order document, while the customer might instead see “request order cancellation” action on the same or associated order document.

Managing roles in this environment may involve segregating documents and flows within appropriate “networks,” which broadly refers to collections of individuals and processes that are have the ability to view and/or contribute to a process. For example, the networks of a mobile user or an organization may define the space of participants that the user or organization can initiate document flows with. As shown in FIG. 3, the mobile client 302 may be configured to maintain networks 306 that are used to initiate document flows with other mobile users (e.g., mobile user 308) or organizations (e.g., organization 310). Some of the networks 306 can be private and maintained only inside the user's mobile device. Other networks (e.g., networks 309) can be maintained by the organizational servers 304 and automatically synchronize to other networks maintained in the organization. For example the organization can have a “sales persons” network 312 another network 314 called “customers.” The customer network 314 can be defined visible to the salespersons network 312 (as indicated by path 316) and the system can takes care of communicating the changes of customers network 314 to the mobile clients 302 in the salespersons network 312, as indicated by path 318.

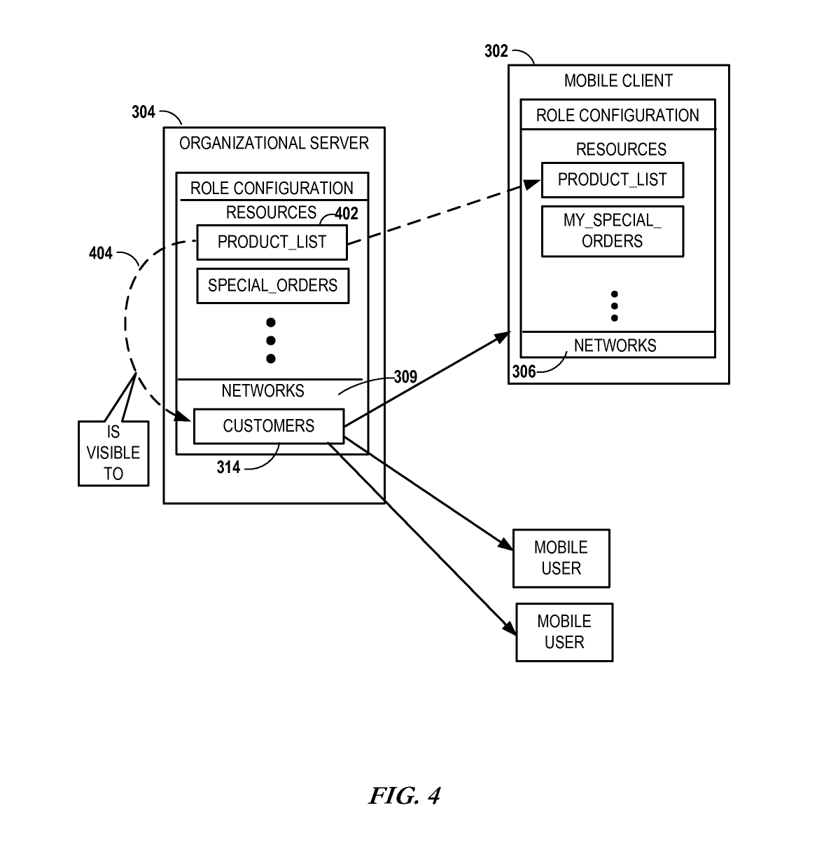

A document flow framework described herein utilizes the concept of a resource. A resource may be any collection of data (e.g., a tabular array), such as a “product list” of a company, and/or binary data like an image. The forms can use the locally available resources in their user interface widgets. For example an “order” form can show a selection list of products that it has fetched from the product list resource. An example of how resources may be configured is shown in the block diagram of FIG. 4, which shows additional aspects of the example mobile client 302 and organizational sever 304 shown in FIG. 3.

The management and visibility of resources may be controlled in a similar way to the networks. A resource can be managed either locally by the mobile client 302 or by an organization which can define the visibility of that resource to given networks. The system takes care of sending the changed resource to the networks in which the resource is made visible. The resource may be managed by an organization at the organizational server 304 and is synchronized as such to the whole given network. For example a product list resource 402 can be visible to the “customers” network 314, as indicated by path 404. In this case all the customers (e.g., client 302 and users 406-407) see the same product list 402.

Sometimes it may be necessary to create dynamically managed views to the resources that can be distributed to different networks. In such case a tabular resource format can be tagged row by row to be visible in different networks. For example organization might have the customers segmented in “keyCustomers” and “regularCustomers”. In this scenario, some rows in the product list 402 can tagged visible only to the “keyCustomers.”

As previously mentioned, the document flow framework described herein, described organizing task management documents into “threads,” where each thread corresponds to a business process. Such a framework is adapted for use in the context and environments shown and described above relative to FIGS. 1A, 1B and 2-4. In the following sections, particular specific implementations of the document flow framework are shown and described.

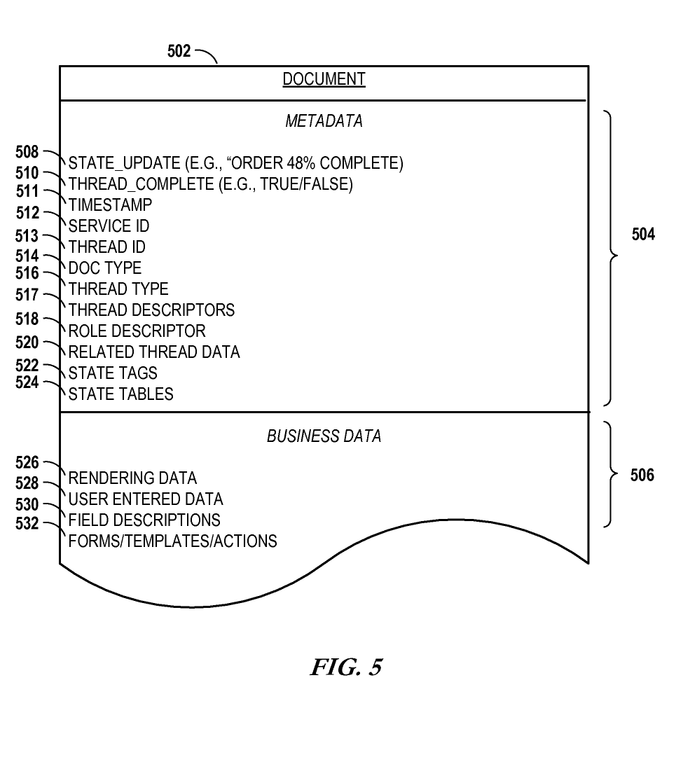

Referring now to FIG. 5, a block diagram illustrates various document data structures according to an example embodiment of the invention. Block 502 represents a document of the document flow framework. The document 502 may be divided into metadata 504 and business data 506, such as described for document 202 in FIG. 2. Various implementations described below may involve including, in the metadata 504, a StateUpdate field 508 which contains a state description. The state description may be either a human-readable description which is shown to the user as-is, and/or it may be a token which is mapped to a human-readable description by the client. The former allows free-form state descriptions such as “Order 48% complete” and the latter allows easy localization and state descriptions that vary depending on user role in the document flow (e.g., customer might see status “Everything received”, whereas supplier sees status “Everything sent”). A combination of the two can also be used, where both a token and a free-form description is supplied, e.g. token is “in-progress” and free-form description is “48%”, and the client combines the two to form the status string “Order in progress (48%).” Note that document type field 514 in the metadata 504 may also be used instead of a separate StateUpdate field 508. The document type 514 in such an embodiment is used as token that is mapped to a human-readable state description by the client. This may require a separate document type to be used for each document that causes a thread state change, but may make a separate StateUpdate field 508 unnecessary.

Thread completion may be handled by listing in the configuration separately for each role the thread states which mean that the thread has been completed from the point of view of that role. Alternatively, each document could carry a “ThreadComplete” flag 510 which is set to true if the document completes the entire thread as seen from a high level view (e.g., completed for all contributors to the process flow). In such a case, the document sender has to know whether the document completes the thread for the receiver. While this is may be feasible, it may be easier if every client only needs to know about its own roles, rather than having to know about everybody else's roles. However, some clients may be at least occasionally interested in the completion of all the roles, such as a high-level manager or system administrator. In such a case, the completion state could be filtered for regular viewing in particular roles, where the state only reflects completion as to that particular role. A composite completion state which reflects completion state for all roles could be viewed by particular clients, either automatically or upon special request.

Note that a thread may be allowed to change state even after it has been completed. For example, a travel reservation thread might be considered completed (from traveler point of view) when the tickets have been sent, but thread state may still change after that to indicate that the travel agent's invoice has been paid. In another example, if the airline cancels or changes the flight and needs to issue new tickets, then the thread state can be updated accordingly.

Updating the state of nested threads via ThreadComplete flag 510 can be handled in a number of ways, including: 1) propagating state updates to all ancestor threads; 2) limiting state updates to the thread to which the document belongs; and/or 3) propagating state updates to all ancestor threads only when the immediate parent thread is completed by document. The first alternative can show fine-grained status no matter which thread is being accessed. However, such detailed status may include information that is irrelevant to the overall process state for a particular role. For example, such detailed status may not be needed or is irrelevant to particular ancestor threads. The second alternative may provide simpler views, however changes in a child thread (even completion of it) may not update the status of the parent thread. The third alternative is a compromise that can work relatively well in many situations. For example, selective state propagation can be useful when there is only one level of nesting and thread state descriptions are chosen carefully so that same description makes sense for both child and parent thread.

Each document also contains a timestamp 511 which generally indicates a date/time associated with a document action. For example, the state of a thread may be determined by the StateUpdate field 508 of the document in the thread that has the latest timestamp 511. The timestamp 511 may be used to indicate data/time for one or more of document creation, modification, approval, submission, deletion, archive, etc.

Other metadata 504 that may be included in the document 502 includes a service ID 513. The service ID 513 describes the service a document belongs to, e.g., travel booking service, home cleaning service, maintenance service etc. In the mobile user interface there may be a separate section for each installed service, and in such a case the service ID 513 may be used to determine in which section the document should appear. The service ID 513 may also function as a sort of namespace for document type 514, so that document types 514 can be assigned without knowing all the existing document types. The document 502 may include a thread ID 514, which may include internal/external references to a particular collection of business tasks that form a thread. The document type 514 may indicate one or more of document data formats, business task for which the document is used, document sub-type (e.g., purchase order-services; purchase order-capital, etc.), document name, etc. Similarly, a thread type 516 may indicate the type of the document's thread at a high level (e.g., purchasing, engineering, sales), or at finer levels of granularity (e.g., engineering: request for quotes: prototyping materials).

The metadata 504 may also include one or more thread descriptors 517. The thread descriptors 517 may include a word description of the thread (e.g., thread subject) and also include a combination of other metadata items, such as thread ID 513, parent thread ID, thread type 516, parent thread descriptor, and/or ancestor thread descriptors. The latter two are represented as related thread data 520. In cases where processes are hierarchical (e.g., thread “nesting” where one process is a sub-thread of a parent), this indicator 520 may identify parent/child threads and be used for purposes of display and updating state appropriately. Other processes may occur in parallel without necessarily requiring a hierarchical relationship. In such a case, the related thread data 520 may indicate a sibling-type relationship between threads.

A role descriptor 518 may include a reference to one or more roles defined in the business model to which the document may pertain. The roles listed in the descriptor 518 need not be limited to those roles that handle the document 502. For example, some business functions such as auditing and quality assurance may have a supervisory role with respect to the business process without actually processing the document 502. The role descriptor 518 may be combined with other metadata 504, for purposes such as filtering/communicating of state updates 508 and thread completion 510. The role descriptors 518 may also include addresses that allow state data (e.g., data 508, 510) to be directly or indirectly communicated to individuals who perform those roles. Such updates may occur in response to creation/or modification of the document 502 by an entity of the business process.

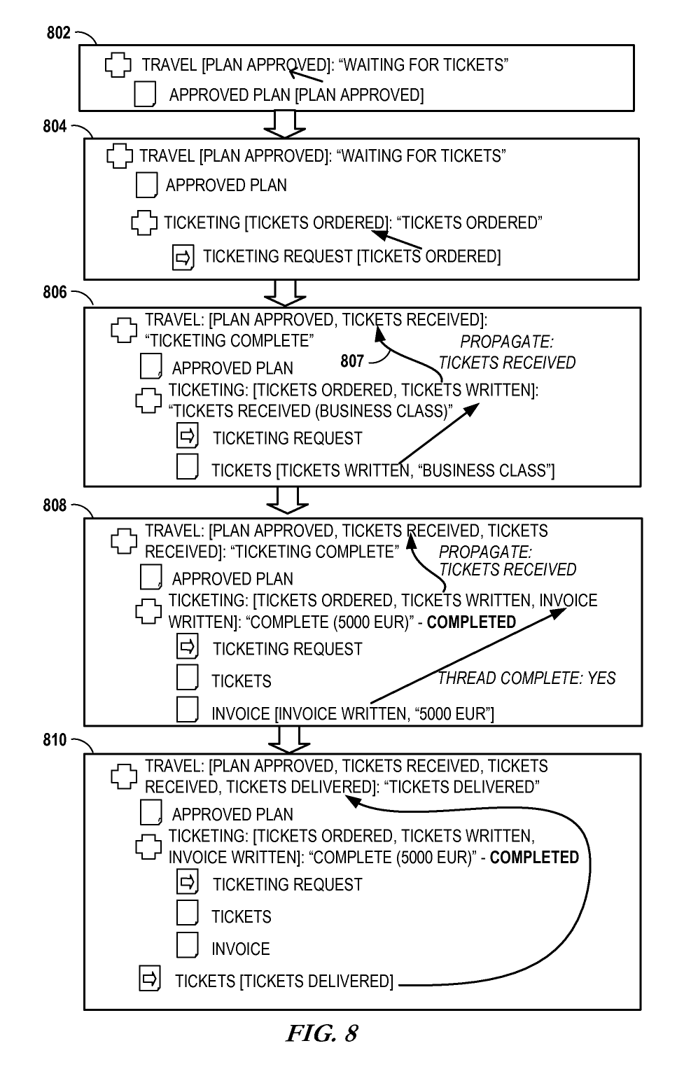

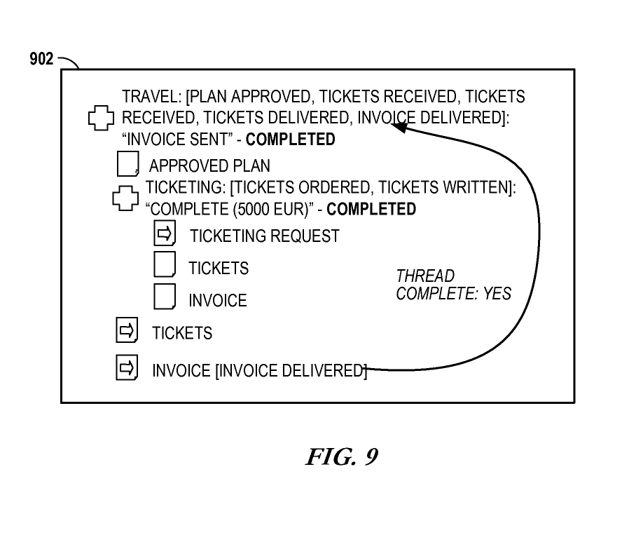

As will be described in greater detail below (e.g., in relation to FIGS. 8-9) the state update indicator 508 is just one way to determine task/document/thread states. The metadata 504 may include state tags 522 and/or one or more state tables 524 instead of or in addition to state update indicator 504. The tags 522 may define, either alone or in combination with the table 524, how state changes to documents or tasks are mapped to changes in thread state. The tags 522 could include the rules of how state changes are to flow (e.g., as in Listing 1 below) or could be used as lookups to the state table 524 which provides those outputs (e.g., as in Table 1 below). Note that the metadata 504 may carry state data 508, 522, 524 that is applicable to multiple roles in a particular process. As such, the ultimate communication of changes to thread/task/document state via the metadata 504 may be tailored for each of the particular roles based on role descriptors 518.

The document 502 includes business data 506 that furthers particular tasks of a process thread, and this data 506 may include rendering data 526 such as text, images, etc., used to render the document 502 for its intended purpose. The document 502 may be adapted for accepting additional user input data 528 as the document is moved between various entities and roles. The user entered data 528 may also be monitored by the system and used to update metadata 504. For example, of the rendered data 526 includes a checkbox, selection of the checkbox may be locally stored as user entered data 528 and may also be used to alter states maintained in the metadata 504.

The input, parsing, and extraction of data 526, 528 from the document may be aided by field descriptions 530, which may be visible or invisible to the user. Such descriptions 530 may be useful, for example, in cases where a document is customized for multiple languages. The field descriptions 530 may be common to all localized versions, thereby easing the extraction of user entered data for purposes such as modifying the metadata 504.

Also shown as part of the business data are forms/templates/actions 532 that may explicitly include functionality that captures some knowledge of the business processes. This data 532 may be included as part of the other user data 526, 528, 530, or may be considered as a separate entity. For example, the document 502 may be formed from a template that include only template data 532, and this template 532 is used, in combination with user inputs, to form the initial metadata 504 and business data 506 of the document 502. The template data 532 may remain in the document 502, such as for generating additional document or sub-documents. In another example, this data 532 may contain processor executable code (e.g., script, embedded binary object) that acts upon the other data 526, 528, 530 based on user inputs and/or other system events.

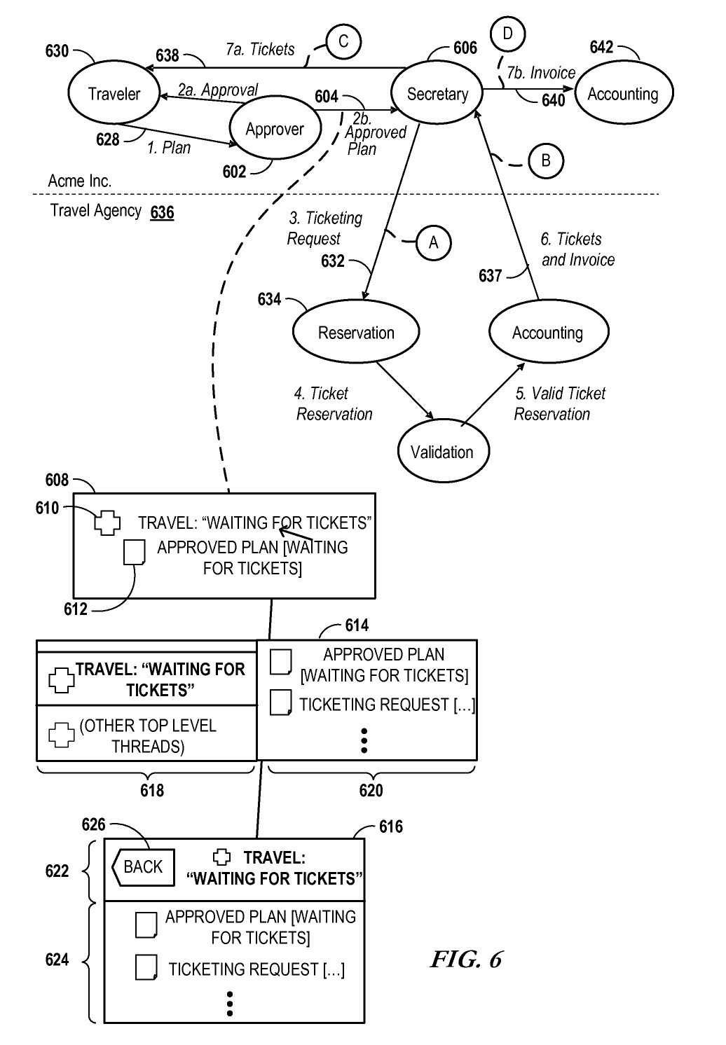

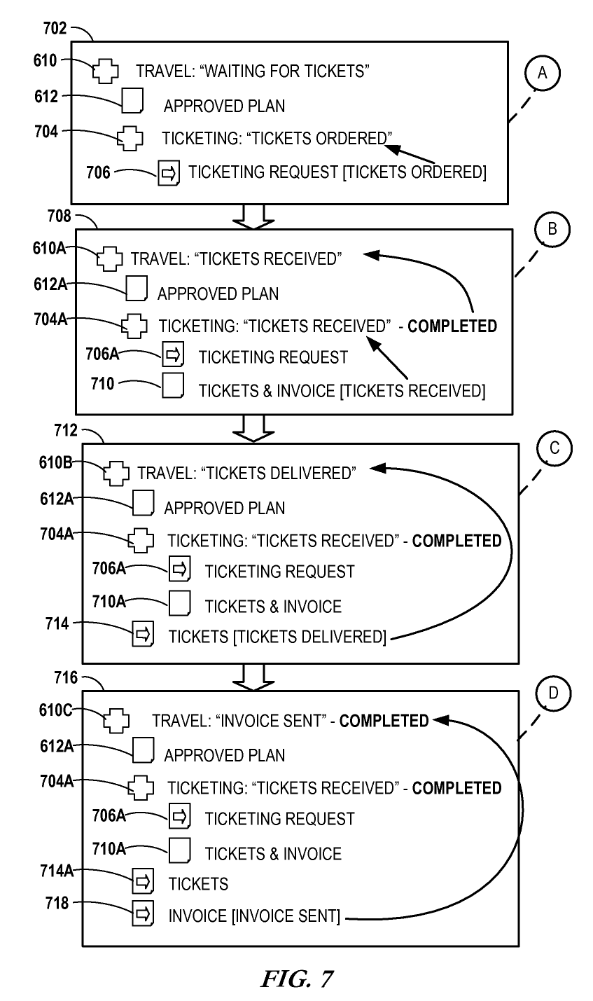

An example of how this document-embedded metadata is used according to example embodiments of the invention is shown in the block diagrams of FIGS. 6-7. In FIG. 6, various roles (e.g., Approver 602) are shown as vertices of a directed graph, with documents (e.g., Approved Plan 604) shown as edges of the graph. The graph in FIG. 6 relates to a particular example of document flow in support of travel planning and ticket reservation. In particular, the views of the document management system (e.g., view 608) are customized for the role of a secretary 606 who processes a number of steps in the travel planning and ticket purchasing operations.

When the secretary 606 has received the Approved Plan document 604, his/her user interface will show a threaded document flow, such as shown in block 608. The cross-shaped symbol 610 denotes a thread, and the paper symbol 612 denotes a document belonging to the thread. Note that while threads are shown here as a fully opened tree view, they could also be displayed one level at a time, similar to a file system. The latter may work better on a mobile device, where limited horizontal screen space makes indentation difficult. Examples of alternate views are shown in blocks 614, 616. In view 614, the selected level of the hierarchy (here the thread level) is shown in left pane 618, and items below the selected level are shown in right pane 620. In the view 616, each hierarchal level is displayed in a “flat” view, with a header portion 622 indicating the current “container,” and a list portion 624 showing all of the items within the container. The user navigates up the hierarchy by selecting control 626, and down the hierarchy by selecting an item from the list 624. Other views known in the art (e.g., directed graph, annotated list, etc.) may also be used as appropriate to the solution domain and target user interfaces.

The travel thread 610 is this instance is established for viewing the process relative to the secretary's role. Thus the travel thread 610 is created in this scenario when an Approved Plan document 604 is received by the secretary 606. Although a travel thread could conceivably be created by some earlier event, e.g., when traveler 630 submits the initial plan 628 to approver 602, this thread is particular to the secretary 606, who may not have any knowledge of that document 628.

The Approved Plan document 604 contains a descriptor for the Travel thread, which may include the subject of the thread (“Travel”), a unique thread ID, and possibly the ID of the thread's parent thread (in case of nested threads. Since this is the first document belonging to that thread that the client 606 has received, no corresponding thread is found on the client 606 and a new one is created and the document is attached to it. The state of the new thread (shown in quotation marks in text associated with icon 610) is set from the StateUpdate field (e.g., field 508 in FIG. 5). The contents of the StateUpdate field are shown in brackets in the descriptive text accompanying icon 612. Note that the bracketed text and arrow shown in view 608 are for purposes of showing the relationship/updates between StateUpdate of the document 612 and state of the thread 610, and is not necessarily part of the user interface.

The secretary 606 next opens the Approved Plan document 604. The form used to open the document allows the secretary 606 to send a Ticketing Request document 632 to the reservations role 634 of travel agent 636. The form copies the Travel thread descriptor to the new document 632. In this example, this portion of the process (e.g., steps taken by agency 636) has been modeled as a sub-process when creating the service. Thus the form also attaches a new thread descriptor “Ticketing” to the document 632, marks the new thread descriptor as the immediate parent of document 532, and marks the old “Travel” thread descriptor as the parent of the new thread descriptor. The StateUpdate field (e.g., field 508 in FIG. 5) is set by the form to contain the text “Tickets Ordered”.

An embodiment of the resulting user interface (e.g., an updated interface based on view 608) is shown in view 702 of FIG. 7. The new thread 704 is shown as a child of thread 610, the new thread containing the ticket request document 706. The icon 706 associated with document 706 (e.g., paper symbol with arrow inside) denotes a sent document. As with view 608, the bracketed text and the thin arrow in view 702 illustrates state propagation and is not necessarily present in the user interface. Note how in view 702 the state of the Ticketing thread 704 is updated by the state of the Ticketing Request 706, but the update is not propagated to the Travel thread 702.

Referring back to FIG. 6, a document 637 containing the tickets and the invoice arrives from the travel agency 636. This document 637 is reflected by icon 710 in view 708 of FIG. 7. Also seen in this view 708, the state of the Ticketing thread 704A is updated based on the StatusUpdate field of the Tickets and Invoice document 710. Since the “Tickets Received” status means that the Ticketing thread is completed (based on one or more of a configured role-specific list of status values which signify thread completion, and/or the THREAD_COMPLETE flag 510 in document metadata 504), the thread 704A is marked as completed. Because the changed state of thread 704A also includes thread completion (e.g., by setting ThreadComplete flag 510 as seen in FIG. 5) the status update is propagated to the parent Travel thread 610A, which now reflects the state of document 710. Note that the bracketed text showing the StateUpdate field contents is only shown for the last message.

Referring back to FIG. 6, the secretary 606 next opens the Tickets and Invoice document 637. The form used to open the document may include a button for forwarding tickets 638 to the traveler 630. The secretary checks the information and then presses the “Forward to traveler” button. The form knows that the new Tickets document does not belong in the Ticketing thread, and removes the Ticketing thread descriptor from the Tickets document and makes the remaining Travel thread descriptor the immediate parent of the document. This is seen in view 712 of FIG. 7. User interface component 714 represents the tickets sent to the traveler, and component 714 indicates that the StateUpdate field of the document is set to “Tickets Delivered”. Because the tickets 714 are the most current document component, the state of the Travel thread 610B now becomes “Tickets Delivered”.

Referring again back to FIG. 6, the secretary 606 later processes all invoices (e.g., at the end of the month). This is done by opening the Tickets and Invoice document 637 again, but pressing “Forward to accounting” button this time. The form requires the secretary to fill in budget-related information (cost codes, estimates etc.) and once complete, sends the Invoice document 640 to accounting 642. This time (based on use of different button) the form sets the StateUpdate field of the new document to “Invoice Sent.” This new document is shown in FIG. 7 as component 718 in view 716. The change of status causes a change in the status of the travel thread 610C, and will also cause the thread 610C to be marked as complete for the secretary 606, based on a configured role-specific list of status values which signify thread completion, and/or or the THREAD_COMPLETE flag 510 in document metadata 504.

The above described scenario may not handle cases where document arrival order is not defined. For example, assume that the travel agency responds to the ticketing request both with a hotel reservation document and a flight reservation document, but the order is determined by which one is found first (e.g., which one arrives first is not known in advance). A desirable behavior in such case is that when hotel reservation document arrives, thread state becomes “Hotel Reserved” if the flight reservation document has not yet arrived, but if the flight reservation document has already arrived, the new state should be “Reservations Complete” (since both flight and hotel reservations have arrived). This could be solved by having each document contain several StateUpdate fields, where each StateUpdate field contains both a new state and a condition for the current state. An example StateUpdate field for the case where a hotel reservation is received in this example is shown below in Listing 1.

Listing 1

```
<StateUpdate currentState=”Flights Reserved”
      newState=”Reservations Complete”/>
<StateUpdate currentState=”Tickets Ordered”
      newState=”Hotel Reserved”/>
Copyright © 2008, Nokia Inc.
```

The full behavior of the example shown in Listing 1 may be modeled as a finite state machine, where transitions between states may be represented by the underlying documents (and/or document states) that trigger particular state transitions. This solution is fairly straightforward to implement, although it may not always scale well with the number of documents that arrive in undetermined order. A state description must be given for each possible combination of received documents, and therefore the total number of descriptions required for n documents is

$${\sum }_{k = 1}^{n} ( \begin{matrix}n \\ k\end{matrix} )$$

(e.g., for, n=5, the number of needed descriptions is 31)

Another feature that may be desirable in a document description framework is to have different state descriptions for ancestor threads, and supporting changing parent thread state in the middle of a child thread. For example, if tickets and invoice were sent by travel agent in separate documents, and tickets sometimes arrive before invoice, then it might make sense for the Travel thread to change state to “Ticketing Finished” whenever the tickets had arrived, even though the Ticketing thread itself was technically not complete because of the missing invoice document. It may not support having different state descriptions for ancestor threads. For example, after receiving the invoice, the Ticketing thread is complete, so it would make sense for its state to be “Finished,” but that cannot be used because the parent thread's state cannot be described as “Finished” at this point.

In order to provide this additional flexibility, each document may carry one or more tags instead of (or in addition to) a state description. Each tag corresponds to an event which has already taken place in the process. A thread receives a tag when a document that contains that tag arrives, and the thread is the immediate parent of the document. Each thread keeps track of which tags it has received, and how many times it has received each tag.

The rules for converting tags to states may be included in the client configuration. To map the rules to threads, it may be desirable to type the threads, e.g., having a thread descriptor also contain the thread's type. This is similar to how a document's type may be indicated, such as via filename extensions, filesystem metadata, and metadata embedded in the file. A configuration that is relevant to the travel thread example may then contain information similar to the following states in Table 1 below.

TABLE 1

| | Thread | | | | Propagate to | |
|---|---|---|---|---|---|---|
| Row | Type | Role | Tags | State | Parent | Complete |
| 1 | Travel | Secretary | InvoiceDelivered | “Invoice | | TRUE |
| | | | | Sent” | | |
| 2 | Travel | Secretary | TicketsDelivered | “Tickets | | false |
| | | | | Delivered” | | |
| 3 | Travel | Secretary | TicketsReceived | “Ticketing | | false |
| | | | (1-2) | Complete” | | |
| 4 | Travel | Secretary | PlanApproved | “Waiting for | | false |
| | | | | Tickets” | | |
| 5 | Ticketing | Secretary | TicketsWritten, | “Complete” | TicketsReceived | TRUE |
| | | | InvoiceWritten | | | |
| 6 | Ticketing | Secretary | InvoiceWritten, | “Invoice | | false |
| | | | TicketsWritten(0) | Received” | | |
| 7 | Ticketing | Secretary | TicketsWritten, | “Tickets | TicketsReceived | false |
| | | | InvoiceWritten(0) | Received” | | |
| 8 | Ticketing | Secretary | TicketsOrdered | “Tickets | | false |
| | | | | Ordered” | | |
| | . . . | . . . | . . . | . . . | . . . | . . . |

It will be appreciated that that the table representation in FIG. 1 is an example embodiment that is presented for purposes of easy readability. In a document framework, computer readable and parseable data structures and/or instructions may be used, such as eXtensible Markup Language (XML) code, binary data formats, embedded binary objects (e.g., Java™ Applets), linked lists, hash sets, etc. A client (or other entity) that tracks thread state may refer to a data structure such as shown in Table 1 each time a tag of a thread change. The client may traverse the table rows in order (top to bottom) and use the first row that matches the thread type, role, and tags, in order to determine the action that should be taken. The Thread Type column gives the thread type that the thread should match. The Role column gives the role the user/participant in the thread needs to match, and the State column gives the new state of the thread. Propagate to Parent gives a list of tags that should be added to the parent thread of the matching thread. If Complete column is true, the matching thread should be marked as complete.Tags gives a list of tag counts that the thread must have to match. A count interval (min-max) may be attached to each tag, and these intervals can be omitted wholly or partly by using a predefined shorthand, as shown below in Table 2.

TABLE 2

| Count interval shorthand | Count interval |
|---|---|
| (n) | (n-n) |
| (n-) | (n-infinity) |
| (-n) | (1-n) |
| Interval not given | (1-infinity) |

Note that according to these rules, a count interval shorthand of (0) means that the tag must not appear in the thread, and no interval means that the tag must appear at least once. By listing states in reverse state progress order, one can omit using the (0) interval in most cases (it may only be required when state progress order is not known in advance). For instance, if the row for “Waiting for Tickets” state were 1st instead of 4th, it might have been necessary to use “PlanApproved, TicketsReceived (0)” in the Tags column instead of just “PlanApproved”.

The intervals are useful in cases like course registration, where you might want to have states “Empty” (0 registrations), “Too few participants” (1-9 registrations), “Confirmed” (10-20 registrations) and “Overbooked” (21 or more registrations). In addition to the tags, a document can also carry free-form state descriptions such as “48% complete”. This will be appended to the state description of the immediate parent thread, but need not propagate to ancestor threads.

In reference now to FIGS. 8 and 9, block diagrams include views of a document management framework according to an alternate example embodiment of the invention. The user interface views in FIGS. 8 and 9 show thread states of the ticket reservation case shown in FIG. 6. This example takes advantage of the flexibility afforded by the use of tags as shown in Table 1.

As seen in view 802 (and similar to the scenario shown in FIG. 6), the Travel thread is created when the Approved Plan document is received. The tags of the new thread (shown in brackets) are copied from the tags of the document (shown in brackets). The state of the thread (shown in quotation marks) is determined by matching the thread's tags to the state table. Each row is examined in order, and the first one that matches is applied. In this case, the row 4 of Table 1, matches and thread state is set to “Waiting for Tickets”:

Next, the secretary opens the Approved Plan document. The form used to open the document allows the secretary to send a Ticketing Request document to the travel agent. The form copies the Travel thread descriptor to the new document. Since this has been modeled as a sub-process when creating the service, the form also attaches a new thread descriptor, “Ticketing,” to the document, marks the new thread descriptor as the immediate parent, and marks the old Travel thread descriptor as the parent of the new thread descriptor. The tags of the new document are set to “TicketsOrdered”. The resulting user interface is shown in view 804. Note in view 804 (as indicated by the arrow) how the tag list of the Ticketing thread is updated by the new document (Ticketing Request). The resulting state of the thread (Tickets Ordered) is determined by matching with row 8 of Table 1.

In this use case, the travel agent may either send tickets and invoice in separate messages, which may arrive in arbitrary order, or the agent may send them both in a single message (similar to the previous use case shown in FIG. 6). The state table allows for all of these cases. However, allowing for a single message to carry both tickets and invoice means that row 5 of Table 1 propagates the TicketsReceived tag, and therefore the Travel thread will receive the TicketsReceived tag a single time if one message is used for both tickets and invoice, and twice if separate messages are used. Hence the row 3 of Table 1 specifies that TicketsReceived may appear 1 or 2 times to match the row. The interval (1-2) is used Table for illustration purposes; the default (1-infinity) that is used when an interval is not given would also work.

In this example, the tickets and invoice arrive separately. First, a document containing the tickets arrives from the travel agency. This is shown in view 808. The tag list of the Ticketing thread is updated based on the tags of the Tickets document. The tag list is compared to the state Table 1, where row 7 matches the “Tickets Written” tag. The freeform text “business class” is appended in parenthesis, so full state for Ticketing thread is now “Tickets Received (business class)”. Since the matching row in the Table 1 contains a Propagate to Parent tag TicketsReceived, that tag is added to the parent (Travel) thread. The new state propagated to the Travel thread is “Tickets Received,” as shown by arrow 809. The Travel thread now matches the third row in the state table, and gets state “Ticketing Complete” (from the Travel thread point of view, ticketing may be complete when tickets have been received, even though the ticketing process might not be complete yet).

Next, a document containing the invoice arrives from the travel agency, as seen in view 808. The tag list of the Ticketing thread is updated based on the tags of the Invoice document. The tag list is compared to the state Table 1. The 5th row of Table 1 matches and new state is “Complete”. The Complete flag on the 5th row is true, so Ticketing thread is now complete (marked with “COMPLETED” in the figure). The freeform text “5000 EUR” is appended to the state description in parenthesis, so full state for Ticketing thread is now “Complete (5000 EUR)”. Since the matching row in the state table contains a Propagate to Parent tag TicketsReceived, that tag is added to the parent (Travel) thread, which now contains the TicketsReceived tag two times. Travel thread still matches the 3rd row in the state table, so its state does not change (e.g., remains “Ticketing Complete”).

Next, the secretary opens the Tickets document. The form used to open the document has a button for forwarding the tickets to the traveler. The secretary checks the information and then presses the “Forward to traveler” button. The form knows that the new document does not belong to the Ticketing thread, and removes the Ticketing thread descriptor from the new document and makes the remaining Travel thread descriptor the immediate parent of the document. The tags of the document are set to “TicketsDelivered,” as seen in view 810. Since the sent document is added to the Travel thread, the TicketsDelivered tag is added to the tags of the Travel thread. The thread now matches the 2nd row in the state table and gets the state description “Tickets Delivered”.

At the end of the month, the secretary processes all invoices. This is done by opening the Invoice document and pressing a “Forward to accounting” button in the form. The form requires the secretary to fill in budget-related information (cost codes, estimates, etc.) and once complete, sends the Invoice document to accounting. The form sets the tags of the new document to “InvoiceDelivered”. Since the sent document is added to the Travel thread, the InvoiceDelivered tag is added to the tags of the Travel thread, as seen in view 910 of FIG. 9. The thread now matches the 1st row in the state Table 1 and gets the state description “Invoice Sent”. The Complete flag on the 1st row is true, so Travel thread is now also complete (marked with “-COMPLETED” in the figure).

As mentioned above, templates can be used to generate documents that are integrated with the document flow framework. The templates can model the knowledge of the business processes and current workflow states. Generally, workflow can be made more efficient through the use of generic and easily customizable content and workflow templates. For example, workflow documents can be customized using metadata descriptions (e.g., XML formatted descriptors) that are created by the workflow participants and/or copied/inherited from other documents in the process flows. This metadata can be entered/gathered using standardized tools, such as a browsers (e.g., via a Web-based wizard). For mobile devices or other apparatus having limited processing and/or network bandwidth, the system may pass only metadata with selected content as first step. If further actions are needed, the user may choose if to download additional attached data (e.g., like in mobile e-mail).

A user or developer can create a workflow template using an easy-to-use wizard or text editor (e.g., in the case of the developer). A template may be created as an XML or eXtensible Hypertext Markup Language (XHTML) document that describes the work/document flow steps and other rules as well. A form may be shown to user for further data entry, and once completed, the documents can be forwarded through the flow to other entities. The document may include embedded XML describing workflow metadata, form descriptions, thread descriptions, thread state tags, etc. The embedded XML may be described hereinbelow as a ‘ticket,’ and may include a minimal set of data that allows a recipient to act on the underlying forms/documents according to the rules of the business process.

For each field of the form there may be several attributes settings. Attributes may include, for example, set particular data fields (including metadata and business data) as “embed” or “attach.” The “embed” attribute may signify that entered data (such as name, address, etc.) is passed inside the form to next step/recipient. The “attach” attribute may signify that an “action” for downloading the attachment is inferred or provided. The option to download content may be beneficial to mobile users in order to improve response time when receiving new documents. A unique Uniform Resource Locator (URL) for such an attachment is generated on fly by server.

Based on metadata and sent contents, a mobile client can generate a user interface on fly (e.g., acting like an XHTML-based browser). The next person in the workflow may change content of permitted fields of form depending roles and restrictions described in template (e.g., field level permissions may include “read only,” “add to existing data,” “modify,” “delete” etc.). The template may be protected by digital signature if desired to protect the template itself as well as portions of resulting documents and metadata (e.g., workflow description), e.g., to protect the integrity of the process and tasks and documents associated with the process. As described in greater detail above, changes to both the documents and metadata embedded in/associated with the documents may be altered by document creation, deletion, modification, etc. As such the dynamically generated user interface may be used to produce various versions of the document for viewing and/or editing. Further, as described above in relation to FIG. 2, where metadata is communicated outside of received electronic documents (e.g., paper document) the workflow templates can also be used to create forms for modifying and communicating the metadata. For example, where a person reviews and signs a paper document, the person may scan a bar code on the document with a mobile device, causing the device to access and present the metadata in an easy to use format (e.g., selection buttons) so that the thread data can be updated accordingly.

Templates of this type may 1) define predefined workflow; 2) provide an “initiator” option to perform a predefined list of steps/tasks of a particular work flow and assign recipients described in template to those particular steps/tasks; and/or 3) give full freedom to search for a “recipient” for each step of the workflow. The “recipient” may include any combination of a user name in service user registry, an e-mail address, and/or Short Message Service (SMS) number. A recipient that is a user of the service will get notified of incoming tickets when connecting to service. An email user may receive an e-mail with link to ticket, and an SMS user may receive a SMS with link to ticket, which can be picked then to workflow client. For example, a Java MIDlet can be configured to start up automatically when new SMS arrives to a predetermined port. Users having account with the service have listing of their open tickets when they access the service using client.

The document framework may include one or more servers that support the following: 1) a user registry in which to search for target individuals/entities and obtain relevant information about those entities (e.g., roles in the business process); 2) a “service” for storing the templates, metadata, and attachments data. 3) a “workflow engine” in devices of documents recipients that can receive and send the tickets (and possibly document in which the tickets may be embedded) to next recipient according to the business rule (which itself may be embedded in the ticket); 4) a “progress notification” service which signals to process initiators and other members who have subscribed to track certain a ticket/thread (e.g., track thread/sub-thread states and completion events); 5) support security features like digital signature verification (e.g., for template part integrity), content encryption. One certificate may be used by the whole system (e.g., authenticated via a verification server) to sign the needed parts of templates when the templates are generated, and verify templates/documents on each submission of it further in workflow.

A workflow client for the described embodiments may be implemented with a client supporting XML parsing and dynamic UI rendering. Such a client may utilize alternative technologies. For example, Nokia WidSets (www.widsets.com) include both client and server components and may be capable of supporting embedding of ticket metadata and dynamic rendering. WidSets allow developers to create widgets that retrieve information from the Web. The widgets can be created in text editor using the WidSets Scripting Language (WSL) to access Web information, provide functionality, and control look and feel of the widget. The WSL is similar to the Java™ programming language and enables developers familiar with Java development to quickly and efficiently create widgets.

In the illustrated embodiments of the document flow framework, a WidSets server could be extended by adding a dynamic workflow engine plug-in to handle various centralized tasks relating to document storage/generation, thread state management, thread state messaging. On the client side, a “Dynamic Workflow Widget” may be deployed to client/mobile devices. As alternative to WidSets client technology, other technologies may be used. For example, form rendering in clients/mobile devices can also be done using existing components like “BrowserComponent” which is heart of Web Runtime (WRT) Widgets in S60 and other platforms. JavaScript and Ajax (asynchronous JavaScript and XML) are supported in WRT, can be used to handle form input submissions, as well handling of attachments loading by request.

In other embodiments, native implementations of the client (e.g., Symbian C++, S40 C, Java, Maemo, etc.) with a native XML parser could interface with the “workflow engine” service. Such a service could then be hosted as a private or public Web service. Desktop clients could use standard browsers, Javascript (e.g., with a special workflow library) and/or Ajax. It will be appreciated that these descriptions of specific user interface technologies are presented for purposes of illustration and not limitation.

As previously described above, because of embodiments may utilize embedded workflow metadata, not every step/task in the business process needs a server connection to advance the workflow and/or communicate a change to thread and document status. For example, the status data could be updated locally and/or via peer-to-peer by passing the ticket to the next step in embedded workflow. When more a more capable (e.g., greater processing/network bandwidth) workflow client handles the ticket, that client could then send pending progress updates to a service. Progress of flow may also be reported to a server by posting to a URL (something like http://..../wfstep?workflow_id=123&step=7). In a client's case, such reporting may be done by sending an SMS with similar content, if the workflow owner is interested in actors at each step reporting progress. Tickets may also be passed forward via a server (push or pull), e-mail, SMS, Multimedia Messaging Service (MMS), etc., as long as receiving device has a client that can retrieve and understand the ticket.

If the workflow templates are in XML, there may be administrators, users, and/or developers who are capable of writing new templates. Entities that engage in standard or well-known business processes may be provided with ready-made templates for ready deployment in those situations (e.g., where an end user arranges a recreational event where different participants have some arrangement responsibilities). Generation/customization of these ready-made templates and the business/document flow logic could be done via a Web based wizard. In such a wizard, end users may enter the number of steps, actions and description text for each step, and add responsible persons (contact info from an address book) for each step. Additionally the user could activate feedback from selected steps, by ticking checkbox, if desired. More advanced features like branching threads, identifying sub-threads, and syncing threads/subthreads could be added in more advanced modes of the wizard. Other types of inputs may also be used, such as by using a GUI for building directed graphs that define business processes, e.g., as shown in FIG. 6.

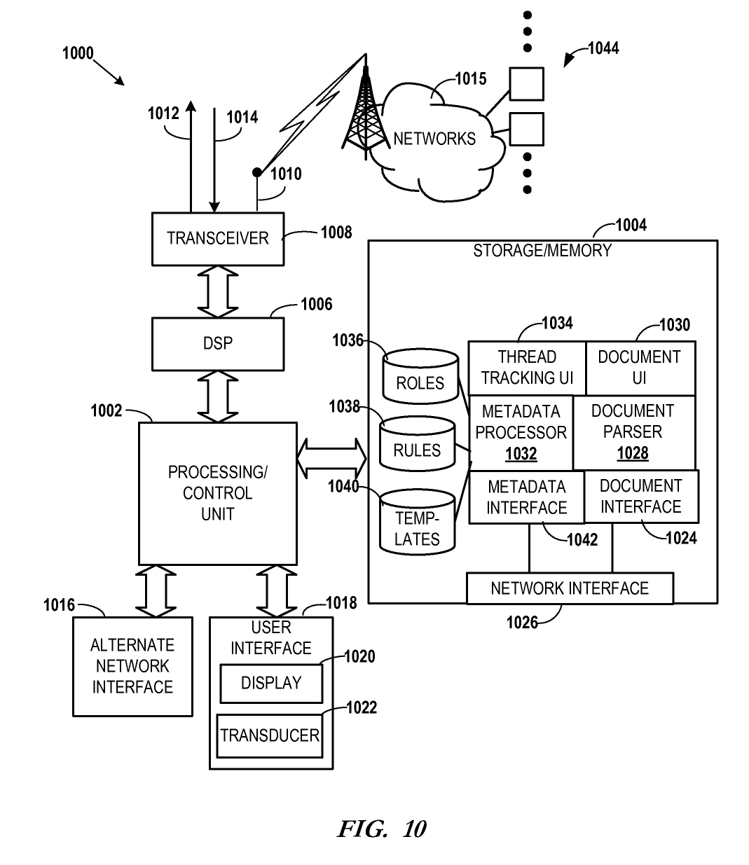

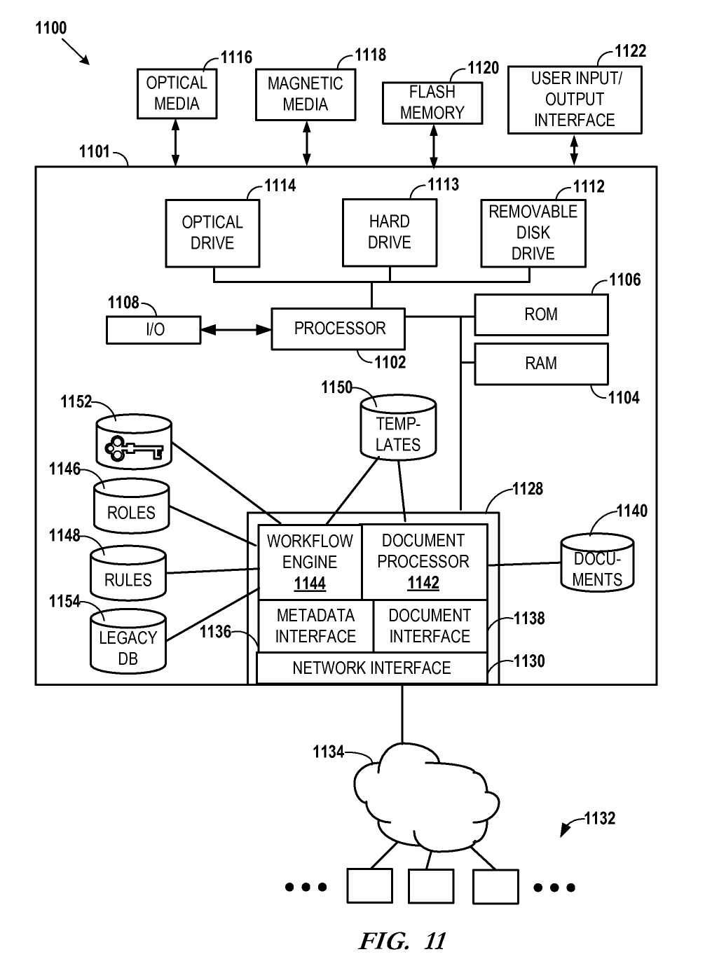

Many types of apparatuses may be used for end-user processing document flows as described herein. For example, users are increasingly using mobile telephones as their primary or secondary computing devices. In reference now to FIG. 10, an example embodiment is illustrated of a representative user computing arrangement 1000 capable of carrying out operations in accordance with an example embodiments of the invention. Those skilled in the art will appreciate that the example user computing arrangement 1000 is merely representative of general functions that may be associated with such user apparatuses, and also that fixed computing systems similarly include computing circuitry to perform such operations. The user computing arrangement 1000 may be for example a mobile computing arrangement, mobile phone, mobile communication device, mobile computer, laptop computer, desk top computer, phone device, video phone, conference phone, television apparatus, digital video recorder (DVR), set-top box (STB), radio apparatus, audio/video player, game device, positioning device, digital camera/camcorder, and/or the like, or any combination thereof Further the user computing arrangement 1000 may include features of the user apparatuses shown in FIGS. 2-4, and may be used to display user interface views as shown in FIGS. 6-9.

The processing unit 1002 controls the basic functions of the arrangement 1000. Those functions associated may be included as instructions stored in a program storage/memory 1004. In an example embodiment of the invention, the program modules associated with the storage/memory 1004 are stored in non-volatile electrically-erasable, programmable read-only memory (EEPROM), flash read-only memory (ROM), hard-drive, etc. so that the information is not lost upon power down of the mobile terminal. The relevant software for carrying out mobile terminal operations in accordance with the present invention may also be provided via computer program product, computer-readable medium, and/or be transmitted to the mobile computing arrangement 1000 via data signals (e.g., downloaded electronically via one or more networks, such as the Internet and intermediate wireless networks).

The mobile computing arrangement 1000 may include hardware and software components coupled to the processing/control unit 1002 for performing network data exchanges. The mobile computing arrangement 1000 may include multiple network interfaces for maintaining any combination of wired or wireless data connections. The illustrated mobile computing arrangement 1000 includes wireless data transmission circuitry for performing network data exchanges. This wireless circuitry includes a digital signal processor (DSP) 1006 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 1008, generally coupled to an antenna 1010, transmits the outgoing radio signals 1012 and receives the incoming radio signals 1014 associated with the wireless device. These components may enable the arrangement 1000 to join in one or more communication networks 1015, including mobile service provider networks, local networks, and public networks such as the Internet and the PSTN.

The mobile computing arrangement 1000 may also include an alternate network/data interface 1016 coupled to the processing/control unit 1002. The alternate network/data interface 1016 may include the ability to communicate via secondary data paths using any manner of data transmission medium, including wired and wireless mediums. Examples of alternate network/data interfaces 1016 include USB, Bluetooth, Ethernet, 1002.11 Wi-Fi, IRDA, Ultra Wide Band, WiBree, etc. These alternate interfaces 1016 may also be capable of communicating via the networks 1015, or via direct and/or peer-to-peer communications links.

The processor 1002 is also coupled to user-interface hardware 1018 associated with the mobile terminal. The user-interface 1018 of the mobile terminal may include, for example, a display 1020 such as a liquid crystal display and a transducer 1022. The transducer 1022 may include any input device capable of receiving user inputs. The transducer 1022 may also include sensing devices capable of producing media, such as any combination of text, still pictures, video, sound, etc. Other user-interface hardware/software may be included in the interface 1018, such as keypads, speakers, microphones, voice commands, switches, touch pad/screen, pointing devices, trackball, joystick, vibration generators, lights, etc. These and other user-interface components are coupled to the processor 1002 as is known in the art.

The program storage/memory 1004 includes operating systems for carrying out functions and applications associated with functions on the mobile computing arrangement 1000. The program storage 1004 may include one or more of read-only memory (ROM), flash ROM, programmable and/or erasable ROM, random access memory (RAM), subscriber interface module (SIM), wireless interface module (WIM), smart card, hard drive, computer program product, or other removable memory device. The storage/memory 1004 of the mobile computing arrangement 1000 may also include software modules for performing functions according to example embodiments of the present invention.

For example, the program storage/memory 1004 includes a document interface 1024 that is configured to send and/or receive process-related documents via one or more network interfaces 1026. The network interface 1026 may include software modules for handling one or more network common network data transfer protocols, such as HTTP, File Transfer Protocol (FTP), Simple Mail Transfer Protocol (SMTP), SMS, MMS, etc. A document parser 1028 may perform actions data structures (e.g., parsing, encoding, decoding, authentication, verification) on incoming and outgoing documents that enable the documents to be rendered on a document user interface 1030. The document user interface 1030 may also accept user inputs for modifying documents, and the parser 1028 may update the data structures of the documents based on these inputs.

As described hereinabove, the documents generally include embedded metadata that is used to track states of business processes in which the documents are used. This metadata may be directly communicated to the apparatus 1000 by way of the document interface 1024, and a metadata processor 1032 may process the metadata independent of the document parser 1028. One use for the metadata is to track and update states of documents, tasks, and threads, and this may be directly shown on the apparatus by way of a thread tracking user interface 1034. The thread tracking user interface 1034 may show process/taskflow status, such as in the example views of FIGS. 6-19, independently of the document user interface 1030.

The determination of documents/tasks/thread state may be dependent on particular roles 1036 and rules 1038 defined for the particular scenario. The roles 1036 may affect how the thread tracking user interface 1034 displays states to a particular user, as well as possibly limiting actions that can be taken via the document user interface 1030. The rules 1038 may define document flows that occur between different roles of a process, and may also define local steps taken in response to an incoming document. For example, processing of an incoming document may require the generation of additional documents, such as via a templates database 1040 and/or via data/templates embedded in the documents themselves. The rules 1038 may further define which other entities 1044 (e.g., clients, servers) of a business process network should be targeted to receive those documents.

As described in greater detail above, the documents processed by the apparatus 1000 may comprise, by themselves, a self-contained indicator of process state that is communicated to other entities 1044 by document transfer. In other arrangements, a metadata interface 1042 may use in-band or out-of-band mechanisms to communicate the metadata (which generally indicates process states) to the other entities 1044. The processor 1032 may direct the interface 1042 to communicate this data based on any combination of data included in locally processed documents, and target addresses/protocols determined via the roles and rules databases 1036, 1038.

The mobile computing arrangement 1000 of FIG. 10 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

In reference now to FIG. 11, a block diagram provides details of a network service 1100 that provides integrated task and document management services according to example embodiments of the invention. The service 1100 may be implemented via one or more conventional computing arrangements 1101. The computing arrangement 1101 may include custom or general-purpose electronic components. The computing arrangement 1101 include one or more central processors (CPU) 1102 that may be coupled to random access memory (RAM) 1104 and/or read-only memory (ROM) 1106. The ROM 1106 may include various types of storage media, such as programmable ROM (PROM), erasable PROM (EPROM), etc. The processor 1102 may communicate with other internal and external components through input/output (I/O) circuitry 1108. The processor 1102 may include one or more processing cores, and may include a combination of general-purpose and special-purpose processors that reside in independent functional modules (e.g., chipsets). The processor 1102 carries out a variety of functions as is known in the art, as dictated by fixed logic, software instructions, and/or firmware instructions.

The computing arrangement 1101 may include one or more data storage devices, including removable disk drives 1112, hard drives 1113, optical drives 1114, and other hardware capable of reading and/or storing information. In one embodiment, software for carrying out the operations in accordance with the present invention may be stored and distributed on optical media 1116, magnetic media 1118, flash memory 1120, or other form of media capable of portably storing information. These storage media may be inserted into, and read by, devices such as the optical drive 1114, the removable disk drive 1112, I/O ports 1108 etc. The software may also be transmitted to computing arrangement 1101 via data signals, such as being downloaded electronically via networks, such as the Internet. The computing arrangement 1101 may be coupled to a user input/output interface 1122 for user interaction. The user input/output interface 1122 may include apparatus such as a mouse, keyboard, microphone, touch pad, touch screen, voice-recognition system, monitor, LED display, LCD display, etc.

The service 1100 is configured with software that may be stored on any combination of memory 1104 and persistent storage (e.g., hard drive 1113). Such software may be contained in fixed logic or read-only memory 1106, or placed in read-write memory 1104 via portable computer-readable storage media and computer program products, including media such as read-only-memory magnetic disks, optical media, flash memory devices, fixed logic, read-only memory, etc. The software may also placed in memory 1106 by way of data transmission links coupled to input-output busses 1108. Such data transmission links may include wired/wireless network interfaces, Universal Serial Bus (USB) interfaces, etc.

The software generally includes instructions 1128 that cause the processor 1102 to operate with other computer hardware to provide the service functions described herein. The instructions 1128 include a network interface 1130 that facilitates communication with entities 1132 of a business process network 1134. The network interface 1130 may include a combination of hardware and software components, including media access circuitry, drivers, programs, and protocol modules. The network interface 1130 may also include software modules for handling one or more network common network data transfer protocols, such as HTTP, FTP, SMTP, SMS, MMS, etc.

The network interface 1130 may be a generic module that supports specific functions of metadata and document interfaces 1136, 1138. The document interface 1138 is configured to exchange process-related documents with network entities 1132. In one embodiment the service 1100 may facilitate central document storage via a repository 1140. Similarly, a templates repository 1150 may provide centralized access to templates used by entities 1132 to generate documents for particular processing tasks. The service 1100 may include a document processor 1142 that manages storage, generation, and routing of documents. As described hereinabove, the documents generally include embedded metadata that is used to track states of business processes in which the documents are used. This metadata may be exchanged with the service by way of the document interface 1142, and a workflow engine 1144 may process the metadata independent of the document processor 1142. One use for the metadata is to track and update states of documents, tasks, and threads, and this may be communicated to clients (e.g., apparatus 1000 in FIG. 10) by way of the documents themselves, and/or the metadata interface 1136. Although the service 1100 may operate without direct user interface hardware, the service 1100 may also be configured with user interfaces (not shown) that allow tracking such metadata and documents (e.g., similar to UI's 1030, 1034 in FIG. 10).

The workflow engine 1144 may determine states of documents/tasks/thread based on particular roles 1146 and rules 1146 defined for the particular task management scenario. The roles 1146 may affect how and to the thread state changes are communicated, as well as possibly limiting actions that entities 1132 can be take on particular documents. The rules 1146 may define document flows that occur between different roles of a process, and may also define steps taken by particular entities 1132 (or the service 1100 itself) in response to an incoming document. For example, processing of an incoming document may require the generation of additional documents, such as via a templates database 1050 and/or via data/templates embedded in the documents themselves. The rules 1148 may further define which other entities 1132 (e.g., clients, servers) of a business process network should be targeted to receive those documents.

As described in greater detail above, the documents processed by the service 1100 may comprise, by themselves, a self-contained indicator of process state that is communicated to other entities 1132 by document transfer. In other arrangements, the metadata interface 1136 may use in-band or out-of-band mechanisms to communicate the metadata (which generally indicates process states) to the other entities 1132. The workflow engine 1144 may direct the interface 1136 to communicate this data based on any combination of data included in locally processed documents, and target addresses/protocols determined via the roles and rules databases 1146, 1148.

The service 1100 may include other centralized functionalities to support business processes. For example, an authentication database 1152 may be used to ensure document integrity, enforce editing restriction on documents 1140 and templates 1150, facilitate document encryption, etc. The task/document/thread states managed by the workflow engine 1144 may also be used to update legacy business process databases 1154.

For purposes of illustration, the operation of the service 1100 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 1101 is only a representative example of network infrastructure hardware that can be used to provide document flow-based services as described herein. Generally, the functions of the computing service 1100 can be distributed over a large number of processing and network elements, and can be integrated with other services, such as Web services, gateways, mobile communications messaging, etc. For example, some aspects of the service 1100 may be implemented in user devices (and/or intermediaries such as servers 204-207 shown in FIG. 2) via client-server interactions, peer-to-peer interactions, distributed computing, etc.

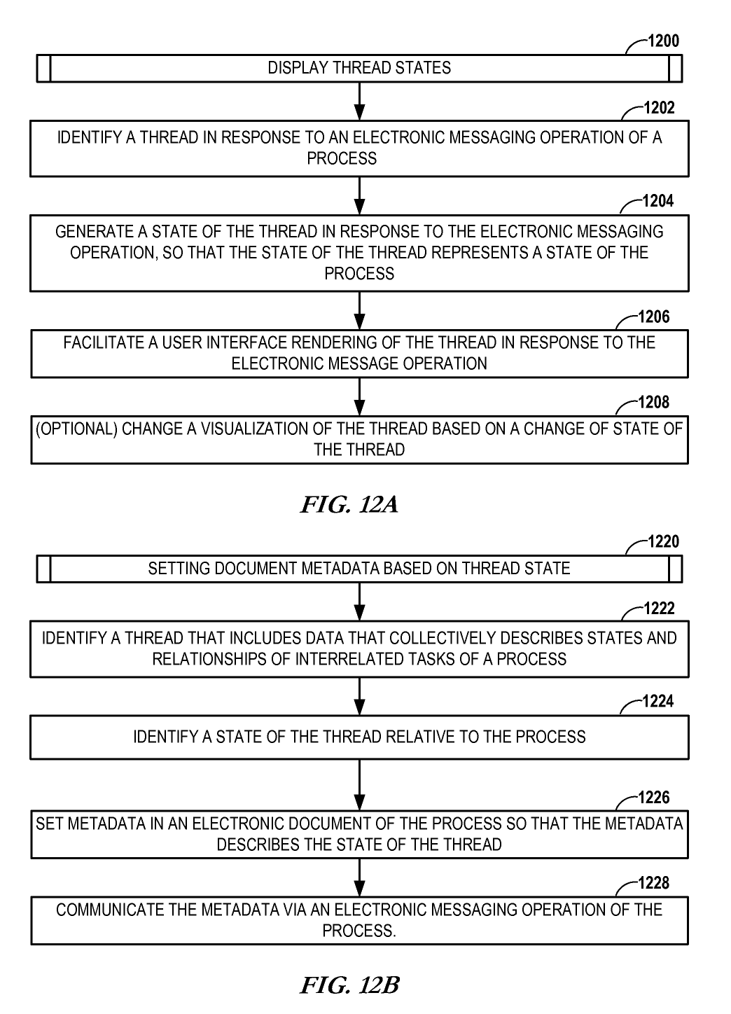

In reference now to FIG. 12A, a flowchart illustrates a procedure 1200 for displaying thread states according to an example embodiment of the invention. The procedure involves identifying 1202 a thread in response to an electronic messaging operation of a business process. The thread may at least include data that collectively describes states and relationships of interrelated tasks of the business process. A state of the thread is generated 1204 in response to the electronic messaging operation, where the state of the thread represents a state of the business process. A user interface rendering of the thread is facilitated 1206 in response to the electronic message operation. Optionally, visualization of the thread may be changed 1208 based on a change of state of the thread

In reference now to FIG. 12B, a flowchart illustrates a procedure 1220 for setting document metadata according to an example embodiment of the invention. The procedure involves identifying 1222 a thread that includes data that collectively describes states and relationships of interrelated tasks of a business process. A state of the thread relative to the business process is identified 1224. Metadata is set 1226 in an electronic document of the business process so that the metadata describes the state of the thread. The metadata is communicated 1228 via an electronic messaging operation of the business process.

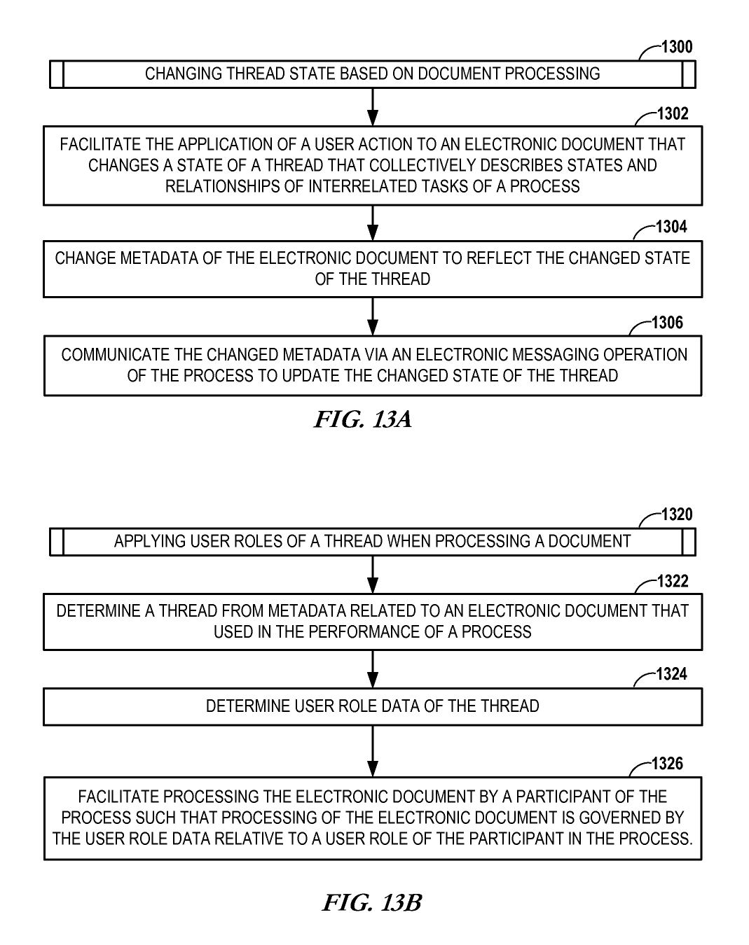

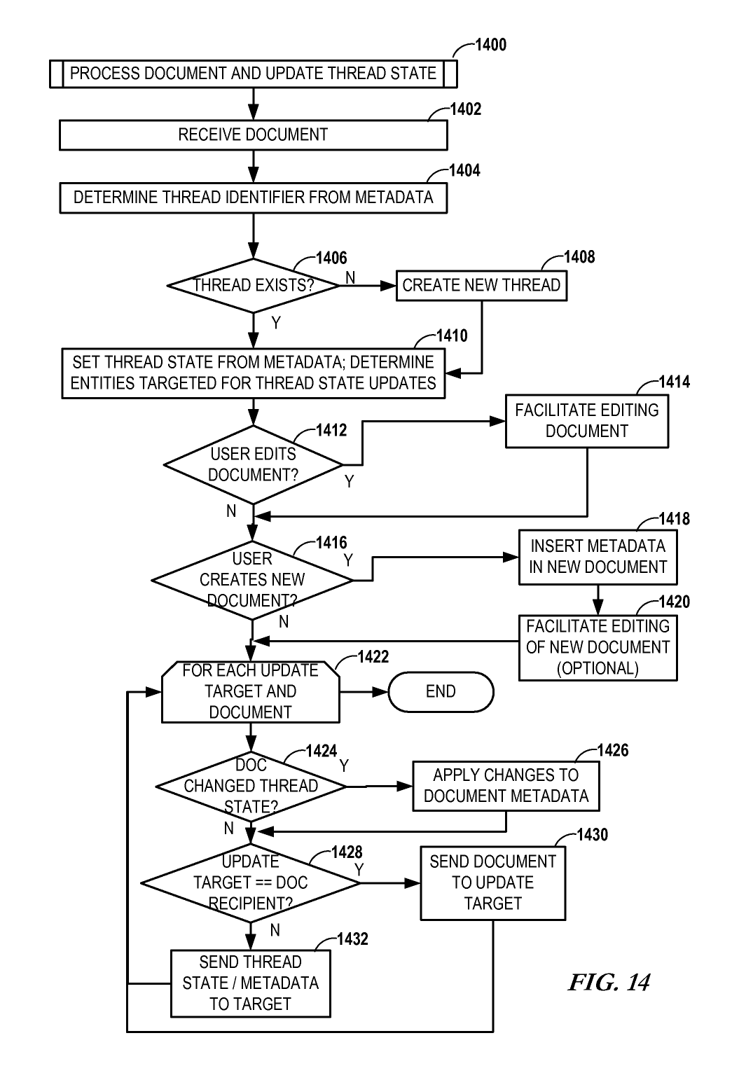

In reference now to FIG. 13A, a flowchart illustrates a procedure 1300 according to an example embodiment of the invention. The procedure 1300 involves facilitating 1302 the application of a user action to an electronic document that changes a state of a thread. The thread at least includes data that collectively describes states and relationships of interrelated tasks of a business process. Metadata of the electronic document is changed 1304 to reflect the changed state of the thread. The changed metadata is communicated 1306 via an electronic messaging operation of the business process to update the changed state of the thread.

In reference now to FIG. 13B, a flowchart illustrates a procedure 1320 according to an example embodiment of the invention. The procedure 1300 involves determining 1322 a thread from metadata related to an electronic document that used in the performance of a business process. The thread at least includes data that collectively describes states and relationships of interrelated tasks of the business process. User role data of the thread is determined 1324, and processing the electronic document by a participant of the business process is facilitated 1326. Processing of the electronic document is governed by the user role data relative to a user role of the participant in the business process

In reference now to FIG. 14, a flowchart illustrates a procedure 1400 according to an example embodiment of the invention. The procedure 1400 generally involves receiving a document 1402 that is involved in a thread, e.g., a number of linked/related transactions of a business process. A thread identifier is determined 1404 from metadata of the document. If it is determined 1406 that the thread does not yet exist (e.g., not locally recorded by the entity processing the document) then a new thread is created 1408. The creation 1408 generally involves creating metadata enabling the thread and its states to be tracked.

The entity processing the document can set 1410 the thread state from metadata and determines entities (e.g., downstream/upstream participants in the thread) targeted for thread state updates. If it is determined 1412 that the user edits the document, then a user interface may facilitate 1414 editing the document. In some cases, the business process may include creating a new document based on the received document. If it is determined 1416 that a new document is created, then metadata (e.g., new data and/or data derived from received document) is inserted 1418 in the new document, and editing is facilitated 1420. Note that editing 1420 is optional; the document could be automatically generated without requiring any user edits.

A loop 1422 iterates through each update target and document. If it is determined 1424 that editing a current document and/or creation of a new document causes a change in thread state, then changes are applied 1426 to the document metadata. If an update target is determined 1428 to be a direct document recipient, then the document may be sent 1430 to that target. Otherwise, the thread state and metadata can be sent 1432 to the target via the usual channels. This sending 1432 of the metadata may occur by out of band mechanisms (e.g., communicated outside of the document). In another case, the entity may eventually, although not directly, receive the document, and in such a case communicating 1432 the state may be accomplished by sending 1430 the document to the next recipient in line, assuming it will eventually reach the target. Note that not all participants in the process need to be informed of or targeted for updates. For example, some participants may only need to see thread status for documents that they handle themselves.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus, comprising:
a processor configured with executable instructions that causes the apparatus to:
determine a thread from metadata embedded in an electronic document that used in the performance of a process via an electronic messaging operation, wherein the thread comprises data that collectively describes states and relationships of interrelated tasks of the process;
determine user role data from the thread; and
facilitate processing the electronic document by a participant of the process, wherein processing of the electronic document is governed by the user role data relative to a user role of the participant in the process.

2. The apparatus of claim 1, wherein the executable instructions further cause the apparatus to update a state of the thread based on processing the electronic document and updating the metadata in response thereto.

3. The apparatus of claim 2, wherein the executable instructions further cause the apparatus to communicate the updated metadata via the electronic messaging operation of the process to communicate the updated state of the thread.

4. The apparatus of claim 3, wherein communicating the updated metadata comprises communicating the metadata embedded in a transferred electronic document that is sent via the electronic messaging operation.

5. The apparatus of claim 1, wherein the executable instructions further cause the apparatus to determine document type data of the electronic document from the metadata, and wherein the processing of the electronic document is further governed by the document type data relative to a document type of the electronic document.

6. The apparatus of claim 1, wherein facilitating processing the electronic document by the participant of the process comprises facilitating of the creation of the electronic document by the participant of the process and embedding the metadata into the electronic document.

7. The apparatus of claim 6, wherein facilitating creation of the electronic document comprises creating the document and the metadata based on a workflow template that models the tasks of the process.

8. The apparatus of claim 1, wherein the metadata comprises a state table that maps the states of the tasks to possible states of the thread.

9. The apparatus of claim 1, wherein the metadata comprises a thread descriptor that indicates an identity of the thread.

10. The apparatus of claim 9, wherein the thread descriptor further comprises at least one of a subject of the thread, identities of participants in the process, and role information of the participants in the process.

11. A method, comprising:
determining a thread from metadata embedded in an electronic document that used in the performance of a process via an electronic messaging operation, wherein the thread comprises data that collectively describes states and relationships of interrelated tasks of the process;
determining user role data from the thread; and
facilitating processing the electronic document by a participant of the process, wherein processing of the electronic document is governed by the user role data relative to a user role of the participant in the process.

12. The method of claim 11, further comprising updating a state of the thread based on processing the electronic document and updating the metadata in response thereto.

13. The method of claim 12, further comprising communicating the updated metadata via the electronic messaging operation of the process to communicate the updated state of the thread.

14. The method of claim 13, wherein communicating the updated metadata comprises communicating the metadata embedded in a transferred electronic document that is sent via the electronic messaging operation.

15. The method of claim 11, further comprising determining document type data of the electronic document from the metadata, and wherein the processing of the electronic document is further governed by the document type data relative to a document type of the electronic document.

16. The method of claim 11, wherein facilitating processing the electronic document by the participant of the process comprises facilitating of the creation of the electronic document by the participant of the process and embedding the metadata into the electronic document.

17. The method of claim 16, wherein facilitating creation of the electronic document comprises creating the document and the metadata based on a workflow template that models the tasks of the process.

18. The method of claim 11, wherein the metadata comprises a state table that maps the states of the tasks to possible states of the thread.

19. A computer-readable storage medium encoded with instructions that, when executed by an apparatus, perform:
determining a thread from metadata embedded in an electronic document that used in the performance of a process via an electronic messaging operation, wherein the thread comprises data that collectively describes states and relationships of interrelated tasks of the process;
determining user role data from the thread; and
facilitating processing the electronic document by a participant of the process, wherein processing of the electronic document is governed by the user role data relative to a user role of the participant in the process.

20. The computer-readable storage medium of claim 19, further comprising updating a state of the thread based on processing the electronic document and updating the metadata in response thereto.

21. The computer-readable storage medium of claim 20, further comprising communicating the updated metadata via the electronic messaging operation of the process to communicate the updated state of the thread.

22. The computer-readable storage medium of claim 21, wherein communicating the updated metadata comprises communicating the metadata embedded in a transferred electronic document that is sent via the electronic messaging operation.

23. The computer-readable storage medium of claim 19, further comprising determining document type data of the electronic document from the metadata, and wherein the processing of the electronic document is further governed by the document type data relative to a document type of the electronic document.

24. The computer-readable storage medium of claim 19, wherein the metadata comprises a state table that maps the states of the tasks to possible states of the thread.

25. A computer-readable storage medium having stored thereon a data structure, comprising:
business data used in furthering completion of one or more tasks of interrelated tasks of a process via an electronic messaging operation;
metadata comprising thread data that collectively describes states and relationships of the interrelated tasks, the thread data further including:
user role data that governs processing of the data structure by a participant of the process in accordance with a user role of the participant; and
document type data that describes a type of at least the business data, and wherein the processing of the data structure is further governed by the document type data relative to the type of at least the business data; and
wherein the metadata is configured to be transferred to other participants of the process via the electronic messaging operation to communicate states of a thread described by the thread data.

26. The computer-readable storage medium of claim 25, wherein the metadata further comprises a state table that maps the states of the tasks to possible states of the thread.

27. The computer-readable storage medium of claim 25, wherein the thread is hierarchically related to another thread of the process, and wherein the metadata describes the hierarchical relation to the other thread.
